(19) United States
(12) Patent Application Publication
(10) Pub. No.: US 2026/0083282 A1
(43) Pub. Date: Mar. 26, 2026

(54) The Griddler

(71) Applicant: SHANE THOMAS, Timnath, CO (US)

(72) Inventor: SHANE THOMAS, Timnath, CO (US)

(21) Appl. No.: 18/891,057

(22) Filed: Sep. 20, 2024

(51) Int. Cl. A47J 47/00

(52) U.S. Cl. CPC A47J 47/005

(57) ABSTRACT

The Griddler is a cutting board designed to securely integrate with outdoor griddles, providing a stable and dedicated surface for food preparation. It features an integrated channel along one side, engineered to engage a vertical edge of the griddle plate, ensuring a secure attachment that prevents movement during use. Unlike existing griddle-specific cutting boards that rest on the cooking surface with support feet, the Griddler's attachment mechanism allows it to remain fixed in place, enhancing safety and usability. The design accommodates various griddle configurations, offering additional preparation space without requiring extra counter or table space. By improving stability and functionality, the Griddler enhances the overall griddle cooking experience.

### BACKGROUND OF THE INVENTION

Outdoor griddles, such as the Blackstone griddle, provide a versatile cooking surface but often lack sufficient space for food preparation. Cutting food directly on the griddle plate is not ideal, as it can damage the surface and interfere with the cooking process. Some existing griddle-specific cutting boards use feet to rest on the cooking surface, but this design lacks stability, as the board can shift during use. To address these limitations, the Griddler is designed to securely integrate with outdoor griddles by engaging a vertical edge of the griddle plate. This ensures a stable and dedicated cutting and preparation surface. This also keeps the cutting surface elevated and away from the direct heat of the griddle, preventing warping or damage that could occur if a cutting board were placed directly on the hot cooking surface. By attaching directly to the griddle, The Griddler enhances the functionality of the cooking setup, offering a convenient workspace without occupying additional counter or table space.

### SUMMARY OF THE INVENTION

The Griddier is a cutting board designed for outdoor griddles, offering a secure, stable surface for food preparation (FIG. 2). It features an integrated channel along the side (FIG. 1a & FIG. 1b), engineered to engage a vertical edge of the griddle plate, such as what is seen on a Blackstone griddle, ensuring stability by preventing movement during use. This attachment mechanism allows the cutting board to remain fixed in place, enabling safe and efficient food preparation directly above or adjacent to the griddle surface. The Griddler is adaptable to various griddle configurations and integrates seamlessly into cooking setups. It enhances functionality by providing additional preparation space without requiring extra counter or table space, making it a versatile and convenient accessory for griddle cooking.

### BRIEF DESCRIPTION OF DRAWINGS

FIG. 1a. A view from above The Griddler. The preparation and cutting surface (101) is shown, along with the channel (103) on the underside of the cutting board, and handles can be seen on either side (102).

FIG. 1b. A view from the side of The Griddler. Handles are shown on either side (102) and the channel is shown (103). The griddle plate (104) is shown to engage The Griddler.

FIG. 2. A perspective drawing showing channel (203), handles (202), and preparation and cutting surface (201) of The Griddler cutting board.

### DETAILED DESCRIPTION OF THE INVENTION

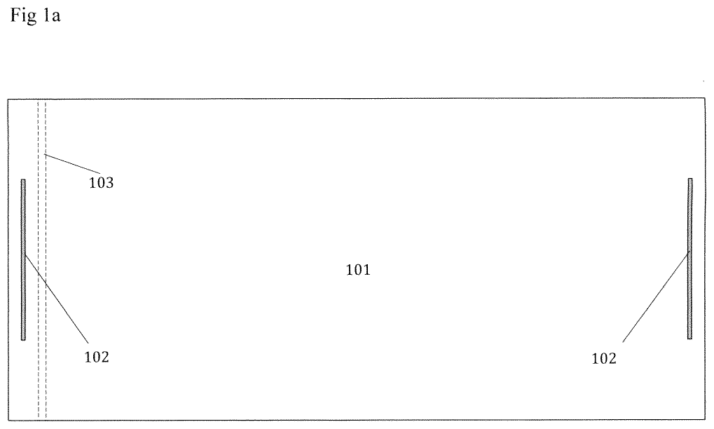

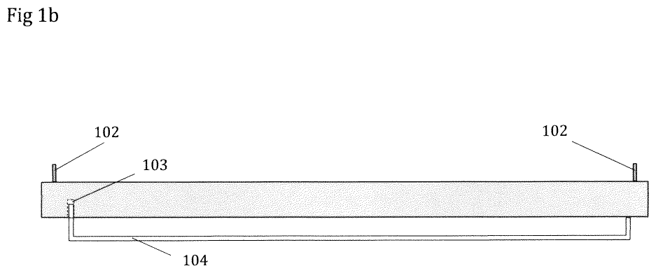

FIG. 1a. A view from above The Griddler. The preparation and cutting surface (101) is shown, along with the channel (103) on the underside of the cutting board, and handles can be seen on either side (102). Handles may vary and are not a necessary element of the overall design.

FIG. 1b. A view from the side of The Griddler. Handles are shown on either side (102) and the channel is shown (103). The griddle plate (104) is shown to engage The Griddler. As depicted here the channel allows the cutting board to attached to the vertical edge of the griddle plate by inserting the griddle plate into the channel.

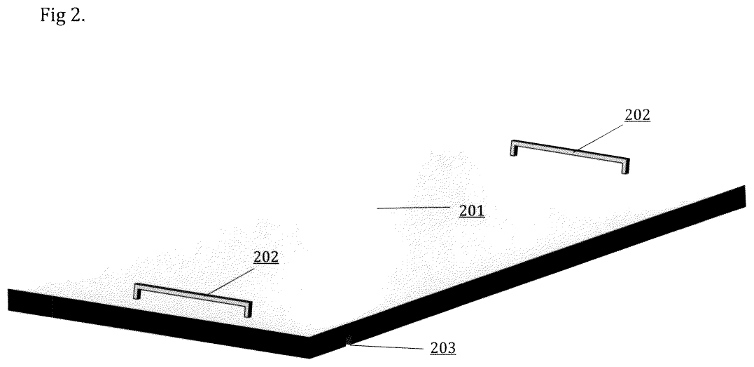

FIG. 2. A perspective drawing showing channel (203), handles (202), and preparation and cutting surface (201) of The Griddler cutting board. Handles may vary and are not a necessary element of the overall design.

1. The Griddler is a cutting board designed for outdoor griddles comprising of an integrated channel on the bottom of the board that allows the cutting board to attach to a vertical edge of the griddle plate, providing a secure preparation and cutting surface.
